(19) United States
(12) Patent Application Publication
(10) Pub. No.: US 2007/0048200 A1
(43) Pub. Date: Mar. 1, 2007

(54) Gas phase reaction processing device

(75) Inventors: Kazuhisa Takao, Kanagawa (JP); Hiroshi Ikeda, Kanagawa (JP); Hideki Matsumura, Ishikawa (JP); Atsushi Masuda, Ishikawa (JP); Hironobu Umemoto, Ishikawa (JP)

Correspondence Address: Carrier, Blackman & Associates, P.C., 24101 Novi Road #100, Novi, MI, 48375, US

(73) Assignee: Tokyo Ohka Kogyo Co., Ltd., Kawasaki-shi (JP)

(21) Appl. No.: 11/511,862

(22) Filed: Aug. 29, 2006

(30) Foreign Application Priority Data
Aug. 31, 2005 (JP) 2005-251059

(51) Int. Cl. B01J 19/08

(52) U.S. Cl. 422/186.04

(57) ABSTRACT

A gas phase reaction processing device 25 comprising a processing chamber 14 into which reactive gas is introduced, substrate material 3 to be processed which is disposed within the processing chamber 14, a catalytic body 9 for decomposing the reactive gas introduced into the processing chamber 14, an electric power unit 10 for supplying power to the catalytic body 9, and an electrode structure 15 containing the catalytic body 9, the gas phase reaction processing device being characterized in that the electrode structure 15 is provided with a plurality of catalytic bodies 9 which are arranged substantially parallel with one another, a first group of terminals 7 and a second group of terminals 8 which are disposed opposite to sandwich this catalytic body 9 therebetween, wherein the first group of terminals 7 supports one end of the catalytic body 9 and the second group of terminals 8 supports the other end of the catalytic body 9 respectively, and a terminal block 6 adapted to support and electrically insulate the first and second groups of terminals 7 and 8.

### BACKGROUND OF THE INVENTION

1. Field of the Invention

The present invention relates to a gas phase reaction processing device which is used to separate, for example, a resist film and the like, using a catalytic body, and more particularly to a gas phase reaction processing device which is suitable for processing a semiconductor wafer of large diameter.

2. Description of the Prior Art

In a conventional technique, in order to separate (remove) a resist film formed on a semiconductor wafer, a method for exciting ashing gas by discharging plasma to ash the resist film is widely used.

However, in this method, non-uniformity of an electric field is produced on the wafer due to the non-uniformity, fluctuation or the like of a plasma electric field. This makes it difficult to get the uniform ashing performance and has an adverse affect on a yield ratio of a semiconductor device as a product. There is also a risk of ultraviolet damage due to emission from the plasma. Further, uniform plasma discharge of a large area is difficult and this has a disadvantage in processing a semiconductor wafer of large diameter.

In order to solve the problems stated above, a separation method using a catalytic body is known (refer to Patent Document 1). In this separation method, a coiled catalytic body like a tungsten wire is disposed above the semiconductor wafer. The catalytic body is then heated at a high temperature to allow it to contact reactive gas for decomposition. The decomposed reactive gas is irradiated on the semiconductor wafer to be processed to conduct separation processing.

[Patent Document 1] Japanese Patent Application Publication No. 2000-294535

In the separation method using the catalytic body described in Patent Document 1 stated above, the coiled catalytic body is used from the aspect of enlarging the contact area of the catalytic body with the reactive gas.

However, referring to the coiled catalytic body, its self-supporting property is so low as to generate looseness at a high temperature and there is a drawback that the distance between the wafer to be processed and the catalytic body changes. Referring further to the uniformity of separation, there is also a problem that the coiled catalytic body can not separate the whole area of the wafer uniformly.

In other words, in the separation method using the coiled catalytic body which was heated at a high temperature, the high-temperature heated coiled catalytic body itself easily becomes loose to cause its self-supporting property to deteriorate. Accordingly, the supporting method for the catalytic body is extremely important to separate the wafer uniformly.

### SUMMARY OF THE INVENTION

It is therefore an object of the present invention to provide a gas phase reaction processing device which can process the whole area of, for example, a semiconductor wafer substantially uniformly and is suitable for processing a semiconductor wafer of large diameter.

In order to attain this object, a gas phase reaction processing device according to the present invention comprises a processing chamber into which a reactive gas is introduced, substrate material to be processed which is disposed within the processing chamber, a catalytic body for decomposing the reactive gas introduced into the processing chamber, an electric power unit for supplying power to the catalytic body, and an electrode structure containing the catalytic body, wherein the electrode structure is provided with a plurality of catalytic bodies, which are arranged substantially parallel to one another, a first group of terminals and a second group of terminals, which are opposedly disposed to sandwich this catalytic body therebetween, the first group of terminals supporting one end of the catalytic body and the second group of terminals supporting the other end of the catalytic body respectively, and a terminal block for supporting and electrically insulating the first and second groups of terminals.

In the gas phase reaction processing device according to the present invention, in order to prevent looseness of the catalytic body itself, which is heated at a high temperature, and to improve the self-supporting property, the catalytic body is composed of a plurality of catalytic bodies which extend parallel to one another. One end of each catalytic body is supported by the first group of terminals, while another end thereof is supported by the second group of terminals and these first and second groups of terminals are supported and insulated on the same terminal block.

With this composition, both ends of each catalytic body are fixedly secured. Thus, even though each catalytic body is heated at a high temperature, it is possible to solve the problem where looseness is produced. Further, since each catalytic body can be arranged in high density, the catalytic body can be arranged in a uniform arranging density over the whole area of the substrate material (e.g., a semiconductor wafer) to be processed and a uniform processing rate can be maintained even for a semiconductor wafer of large diameter.

### BRIEF DESCRIPTION OF THE DRAWINGS

The above and other objects, features and advantages of the present invention will become more apparent from the following description when taken in conjunction with the accompanying drawings.

FIG. 1 is a schematic structure view showing one embodiment of a gas phase reaction processing device according to the present invention;

FIG. 2 is a structure view showing the electrode structure of FIG. 1;

FIG. 3 is a schematic structure view showing another embodiment of a gas phase reaction processing device according to the present invention;

FIG. 4 is a view showing another embodiment of a catalytic body;

FIG. 5 is a view explaining a connecting pattern between the catalytic body and an electric power unit (first pattern);

FIG. 6 is a view explaining a connecting pattern between the catalytic body and the electric power unit (second pattern); and

FIG. 7 is a view explaining a connecting pattern between the catalytic body and the electric power unit (third pattern).

### DETAILED DESCRIPTION OF THE PREFERRED EMBODIMENTS

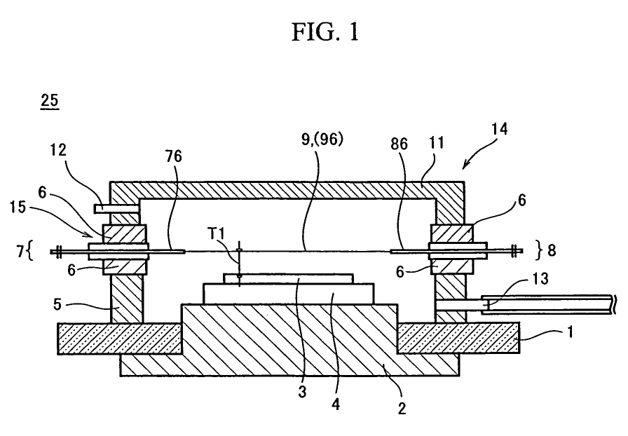

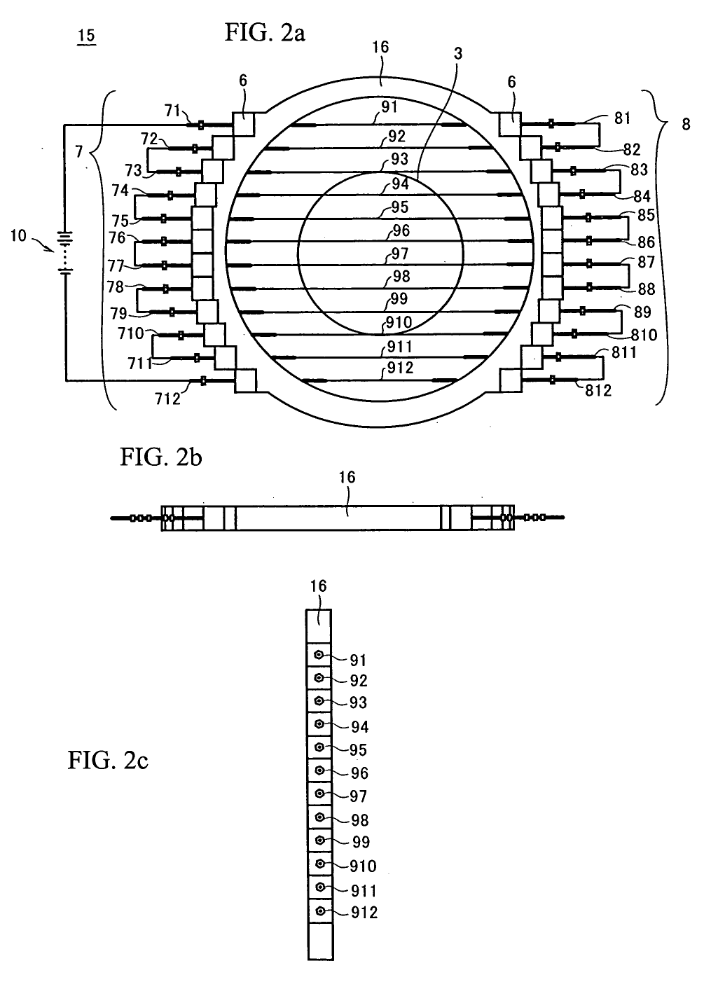

A preferred embodiment of the present invention will now be described with reference to the accompanying drawings. FIG. 1 is a schematic cross-sectional view showing one embodiment of a gas phase reaction processing device according to the present invention. FIG. 2A is a top view showing the gas phase reaction processing device of FIG. 1 without a cap, FIG. 2B is a front view of FIG. 2A, and FIG. 2C is a side view of FIG. 2A as seen from the lateral direction (i.e., the right direction) of the surface of this paper.

In the gas phase reaction processing device 25 according to the present embodiment, as shown in FIGS. 1 and 2, a stage 2 is hermetically secured to a base member 1 through a sealing member (not shown). A susceptor 4 for supporting substrate material (e.g., a semiconductor wafer) to be processed is disposed on the stage 2. A cylindrical base ring 5 is mounted on the base member 1 in an airtight manner through a sealing member. Hermetically mounted on this base ring 5 are a first group of terminals 7 and a second group of terminals 8 which support each catalytic body 9, and a terminal block 6 made of insulating material for supporting and electrically insulating these first and second groups of terminals 7 and 8. The first and second groups of terminals 7, 8 and the terminal block 6 constitute an electrode structure described later. A cap 11 is mounted on this terminal block 6 in an airtight manner.

The base ring 5 is provided with an outlet 13 for discharging reactive gas generated by the gas phase reaction processing, while the cap 11 is provided with an inlet 12 for introducing the reactive gas into a processing chamber described later. Reference numeral 10 is an electric power unit for supplying power to each catalytic body 9.

The stage 2 is connected to an elevating mechanism (not shown) to move vertically and the wafer 3 can be exchanged by the elevating operation of the stage 2.

An organic film (not shown) such as a resist film is formed on the surface of the wafer 3 and this organic film is separated (removed) by the gas phase reaction processing.

In such a gas phase reaction processing device 25, the base member 1, the stage 2, the base ring 5, the terminal block 6, and the cap 11 constitute the processing chamber 14.

In the present embodiment, the electrode structure 15 is especially composed of a plurality of catalytic bodies 9 (of a wire or linear shape) which are arranged substantially parallel with one another; a first group of terminals 7 and a second group of terminals 8 which are opposedly disposed to sandwich each catalytic body 9 therebetween, wherein the first group of terminals 7 supports one end (i.e., the left side of FIG. 2A) of each catalytic body 9 and the second group of terminals 8 supports the other end (i.e., the right side of FIG. 2A) of each catalytic body 9 respectively; and the terminal block 6 for supporting and electrically insulating the first and second groups of terminals 7 and 8.

The terminal block 6 has a cylindrical base 16 to which the first and second groups of terminals are secured to face one another.

The first and second groups of terminals 7 and 8 are respectively provided with 12 terminals (71-712) (81-812) which are electrically insulated by insulating materials, respectively.

The first and second groups of terminals 7 and 8 are provided so that one end of each terminal is situated within the processing chamber 14 to support one end of each catalytic body 9 and the other end of the terminal is situated outside the processing chamber 14.

The ends of each catalytic body 9 are gripped by the first and second groups of terminals 7 and 8. In the first and second groups of terminals 7 and 8, adjacent terminals are connected to one another, and two terminals (71 and 712 of FIG. 2A) on both ends are connected to the electric power unit 10 through an electric connecting member provided outside, wherein 12 terminals 9 (91-912) are electrically connected in series with the electric power unit 10. In this manner, a uniform electric current is supplied to each catalytic body 9 (91-912).

For example, a wire of a high-melting point metal such as a tungsten wire is available for the catalytic body 9. In addition, not only a wire of a high-melting point metal such as platinum and molybdenum, but also linear ceramics on which a film of a high-melting point metal such as tungsten, platinum, molybdenum, palladium and vanadium is formed can be used as the catalytic body 9.

Next, separation of the resist film formed on the wafer 3 using such a gas phase reaction processing device 25, that is, the gas phase reaction processing will now be described hereunder.

First, the stage 2 is lowered by driving the elevating mechanism (not shown) connected thereto to mount the wafer 3 to be processed on the susceptor 4.

The stage 2 is then elevated to be secured to the base member 1 in an airtight manner. With this operation, the wafer 3 can be disposed within the processing chamber 14.

Next, air is discharged from the processing chamber 14 to put it under reduced pressure before processing. The reactive gas is introduced into the processing chamber 14 through the inlet 12 and the electric power unit 10 is actuated to resistance-heat the catalytic body 9.

Referring to the reactive gas, H₂ gas is used as reducing gas and a constant current power unit is used as the electric power unit 10.

With this operation, the temperature of each catalytic body 9 is gradually increased, for example, to about 1,800° C. H₂ gas introduced into the processing chamber 14 receives the thermal energy from the catalytic body 9 for decomposition and is irradiated on the surface of the wafer 3. Thus, the resist film is separated by the chemical reaction and the action of collision or the like of the gas to the resist film surface.

The reactive gas generated in the course of gas phase reaction processing is discharged outside through the outlet 13.

As a result, damage to the wafer 3 is reduced and the resist film can be separated from the wafer 3 without causing ultraviolet damage.

According to the gas phase reaction processing device 25 of the present embodiment, the catalytic body 9 is formed by a wire of tungsten and 12 catalytic bodies 9 (91-912) are disposed parallel to one another. In this manner, the electrode structure 15 is formed within a flat surface with the catalytic bodies 9 being spaced a predetermined distance T1 apart above the wafer 3 supported on the susceptor 4.

With this arrangement, each catalytic body 9 (91-912) can be distributed substantially uniformly over (for) the whole area of the wafer 3 to further increase the uniformity of processing. Accordingly, it is possible to supply the decomposed H₂ gas substantially uniformly over the whole area of the wafer 3 even in the case of processing a wafer 3 of large diameter.

What is more important is that both ends of each catalytic body 9 (91-912) are supported respectively. In the case of separation processing using the catalytic body, the catalytic body 9 in process is heated to about 1800° C. and becomes loose to cause its self-supporting property to deteriorate. However, by supporting both ends of each catalytic body 9 (91-912) with the terminals (71-712, 81-812) respectively, generation of flexure can be effectively prevented and the distance T1 between the surface of the wafer 3 and the catalytic body 9 can be always maintained constant. In particular, as shown in the present embodiment, by supporting both ends of each catalytic body 9 (91-912) which extend linearly with the terminals (71-712, 81-812), the catalytic body 9 is supported at the shortest distance in the extending direction and the amount of flexure during processing can be minimized.

As a result, it is possible to set the temperature of the catalytic body 9 during processing at a lower temperature because the catalytic body 9 can be disposed close to the wafer 3 to be processed. It is also possible to supply the decomposed H₂ gas to the wafer 3 at a high density because the linear catalytic body 9 can be set at a high arranging density.

Further, in the gas phase reaction processing device 25 according to the present embodiment, the ends on the side supporting each catalytic body 9 (91-912) are situated within the processing chamber 14, while the ends on the opposite side of the side supporting the catalytic body 9 are situated outside the processing chamber 14. With this arrangement, an advantage that the connection between each catalytic body 9 and the electric power unit 10 is easily made can be attained.

In other words, in the case where the terminal block 6 is disposed in the internal space of the processing chamber 14, it is necessary to take necessary measures to establish a connection between the first and second groups of terminals 7 and 8 for supporting and electrically connecting each catalytic body 9 (91-912) and the external power unit 10.

On the contrary, if the ends of the first and second groups of terminals 7 and 8 on the opposite side of the side supporting each catalytic body 9 (91-912) are situated outside the processing chamber 14, it is possible to establish a connection between the terminals (71-712, 81-812) using an existing power cable. It is to be noted that various electric connections can also be established between each catalytic body 9 (91-912) and such connections can be suitably set depending upon the characteristics of the object to be processed.

For example, by making the arranging density of each catalytic body 9 (91-912) high, an electric current can be supplied to every one or two catalytic bodies depending upon the characteristics of the resist film to be processed.

Further, in the gas phase reaction processing device 25 of the present embodiment, since each catalytic body 9 is electrically connected in series with the first and second groups of terminals 7 and 8 (71-712, 81-812) and each catalytic body 9 is connected in series with the electric power unit 10, it is possible to maintain the current flowing through each catalytic body 9 constant.

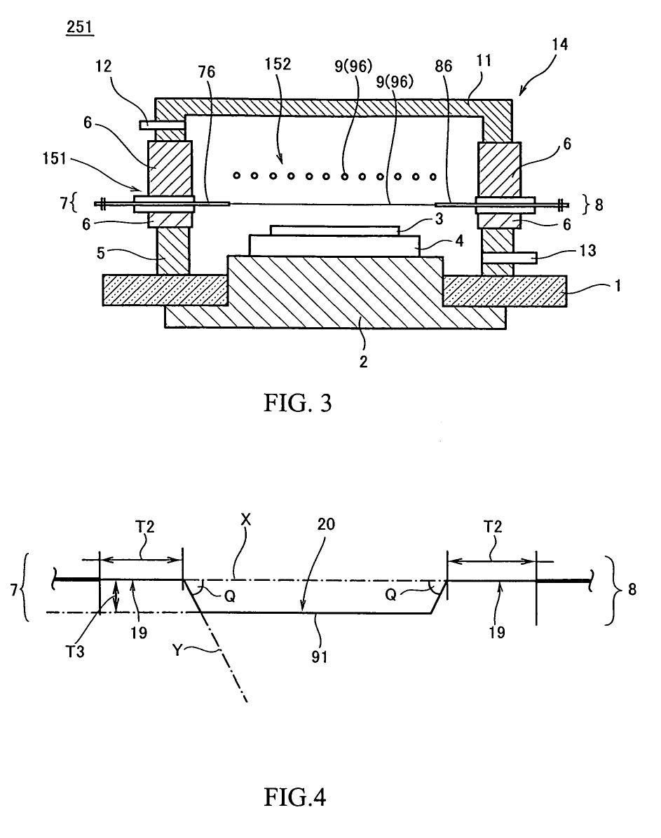

Next, another embodiment of a gas phase reaction processing device according to the present invention will now be described with reference to FIG. 3.

FIG. 3 is a schematic structure view showing another embodiment of a gas phase reaction processing device according to the present invention.

In the gas phase reaction processing device 251 of the present embodiment, a second electrode structure 152 is disposed to extend in the direction perpendicular to the extending direction of a first electrode structure 151.

This second electrode structure 152 has the same configuration (structure, composition) as the first electrode structure 151 and is supported by a third and fourth groups of terminals (not shown) provided on the terminal block 6 which supports the first and second groups of terminals 7 and 8.

In other words, in the gas phase reaction processing 251 according to the present embodiment, the second electrode structure 152 which has the same configuration as the first electrode structure 151 is disposed in a multistage manner relative to the first electrode structure 151, and the arranging direction of the catalytic body 9 in the second electrode structure 152 is disposed at a predetermined angle (0-90°) with the arranging direction of the catalytic body 9 in the first electrode structure 151.

Referring to FIG. 3, the second electrode structure 152 is disposed above the first electrode structure 151 and the arranging direction of the catalytic body 9 in the second electrode structure 152 is arranged at an angle of 90° with the arranging direction of the catalytic body 9 in the first electrode structure 151. Namely, as described above, the arranging direction of the catalytic body 9 in the second electrode structure 152 is disposed at right angles to the arranging direction of the catalytic body 9 in the first electrode structure 151.

Since the configuration other than these electrode structures 151 and 152 is the same as the gas phase reaction processing device 25 of the first embodiment stated above, repeated explanation is omitted.

As just described, according to the gas phase reaction processing device 251 of the present embodiment in which two electrode structures (151 and 152) with the same configuration, of which the catalytic bodies 9 meet at right angles, are multistagedly arranged, it is possible to further increase the number of arrangements of each catalytic body 9 (91-912) per unit area and make the separation rate of the resist film relative to the wafer 3 more constant.

In the gas phase reaction processing device 251 of the present embodiment, a case where the arranging direction of the catalytic body 9 in the second electrode structure 152 crosses at right angles to the arranging direction of the catalytic body 9 in the first electrode structure 151 is described, but the relationship of the arranging direction of the catalytic body 9 is not limited to this case, so that various modifications can be considered.

In the gas phase reaction processing devices (25,251) according to the embodiments described above, the catalytic body 9 of a wire shape linearly extending over the entire length between the first and second groups of terminals is used, but a catalytic body 91 composed of a linear section 19 and a step section 20 can also be used between the first and second groups of terminals 7 and 8.

Specifically, as shown in FIG. 4, the catalytic body 91 is composed, between the first and second groups of terminals 7 and 8, of the linear sections 19 which are respectively formed at a predetermined distances T2 from each group of terminals 7 and 8 and the step section 20 which is formed between these linear sections 19.

The predetermined distance T2 of the linear section 19 is formed within, for example, 0-50 mm, and an angle formed between an extension line X of the linear section 19 and an extension line Y of the step section 20 is formed within, for example, 0-90°. The distance T3 between the linear section 19 and a bottom of the step section 20 is formed within, for example, 0-20 mm.

In this manner, by using the catalytic body 91 formed by the linear section 19 and the step section 20, it is possible to further reduce generation of cutting due to deterioration of the catalytic body 9 resulting from repetition of expansion and contraction compared with the catalytic body 9 which linearly extends over the entire length as shown in FIG. 2A.

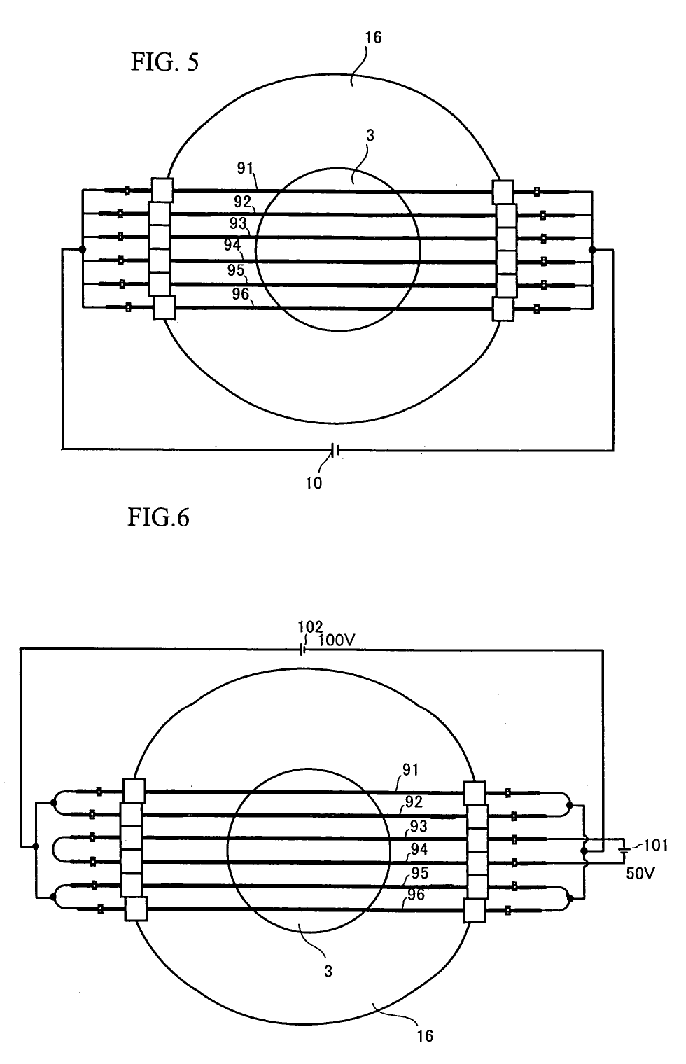

Further, in the gas phase reaction processing device (25, 251) according to each embodiment described above, a case where each catalytic body 9 is connected in series with the electric power unit 10 is described, but as shown in FIG. 5, each catalytic body 9 can be connected in parallel with the electric power unit 10. In other words, as shown in FIG. 5, for example, 6 catalytic bodies 9 (91-96) are connected in parallel with the electric power unit 10.

Referring to FIGS. 2 and 5, a case where, as a connecting pattern (a connecting structure) between the catalytic body 9 and the electric power unit 10, each catalytic body 9 is connected in series or in parallel with one electric power unit 10 is described. However, it is also possible to use a plurality of electric power units 10 depending upon the size of the wafer 3 or the number of the catalytic bodies 9 and also mix a pattern in which each catalytic body 9 is connected in series and a pattern in which each catalytic body 9 is connected in parallel.

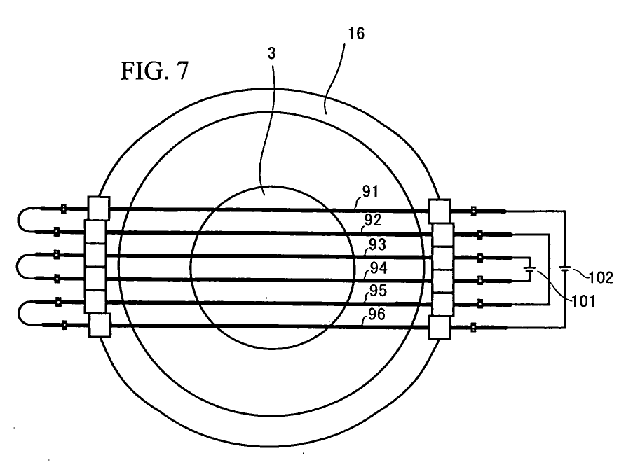

More specifically, in the case where the size of the wafer 3 is large, it can be considered that the temperature difference between the central position and the peripheral position of the wafer 3 being processed becomes significant (for example, the temperature is high in the central position of the wafer 3 and low in the peripheral position thereof). In such a case, as shown in FIG. 6, the catalytic body 9 (93 and 94) corresponding to the central position of the wafer 3 can be connected in series with an electric power unit 101, while the catalytic body 9 (91 and 92; 95 and 96) corresponding to the peripheral position of the wafer 3 can be connected in parallel with an electric power unit 102. In this case, the temperature of the central position and the peripheral position of the wafer 3 can be kept uniform by applying low voltage (e.g., 50V) to the electric power unit 101 and applying, for example, high voltage (e.g. 100V) to the electric power unit 102.

Further, as shown in FIG. 7, the catalytic body 9 (93 and 94) corresponding to the central position of the wafer can be connected in series with the electric power unit 101, while each catalytic body 9 (91 and 92; 95 and 96) corresponding to the peripheral position can also be connected in series with the electric power unit 102.

The connecting pattern between the catalytic body 9 and the electric power unit 10 is not only the structure shown in FIGS. 5-7, but also various patterns can be considered depending upon the size of the wafer 3 to be processed, the number of catalytic bodies 9, and the number of electric power units 10.

Also, in the gas phase reaction processing device (25, 251) of each embodiment described above, the resist film on the wafer 3 is separated using the reducing gas (H₂) as the reactive gas, but the resist film on the wafer 3 can also be separated using, for example, oxidizing gas.

As described above, when the gas phase reaction processing device (25,251) is used making use of an oxidative reaction, a reactive gas is used in which an oxidizing gas is added to an inactive gas. Referring to the catalytic body 9 used in this case, the catalytic body composed of the same metallic material as in the case of using the reducing gas can be used.

Further, in the gas phase reaction processing device (25, 251) of each embodiment described above, a case where H₂ is used as the reactive gas in the case of conducting separation processing making use of the reducing reaction is described. However, He, Ne, Ar and N2 as a diluent gas or carrier gas, or a reactive gas in which H₂ is added to an inactive gas, which is a mixture of He, Ne, Ar and N2, can also be used.

Still further, in the gas phase reaction processing device (25, 251) of each embodiment described above, the terminal block 6 supporting the terminal of the electrode structure 15 (the first electrode structure 151) forms part of the processing chamber 14, but another processing chamber can also be provided to dispose the electrode structure 15 within the processing chamber 14.

In the gas phase reaction processing device (25,251) of each embodiment described above, an example whereby the whole area of the wafer 3 is uniformly processed is described, but it is also possible to selectively conduct separation processing only on a specific area of the wafer 3, or it may be used as an etching processing device.

Further, in the gas phase reaction processing device (25, 251) of each embodiment described above, a case where the resist film formed on the semiconductor wafer 3 is separated is described, but it is also possible to apply this device to other cases where various films or layers are separated (removed).

It will be understood that the present invention is not limited to the embodiments described above, but may be varied in many ways without departing from the spirit and scope of the invention.

### EFFECTS OF THE INVENTION

According to the gas phase reaction processing device of the present invention, generation of looseness in the catalytic body can be drastically reduced. Further, the catalytic body can be arranged in a uniform arranging density over the whole area of the substrate material (e.g., the semiconductor wafer) to be processed. Thus, it is possible to maintain a uniform processing rate even for a semiconductor wafer of large diameter.

In this manner, it is possible to provide a high-performance and reliable gas phase reaction processing device.

1. A gas phase reaction processing device for processing a substrate comprising:
a processing chamber in which a substrate may be disposed and into which reactive gas may be introduced;
a catalytic body for decomposing the reactive gas introduced into the processing chamber;
an electric power unit for supplying power to the catalytic body; and
an electrode structure associated with the catalytic body;
wherein the catalytic body includes a plurality of catalytic members which are arranged substantially parallel with one another; and the electrode structure includes a first group of terminals and a second group of terminals which are opposedly disposed to sandwich the catalytic body therebetween, wherein the first group of terminals supports one end of the catalytic body and the second group of terminals supports the other end of the catalytic body respectively, and a terminal block supporting and electrically insulating the first and second groups of terminals.

2. The gas phase reaction processing device according to claim 1, wherein the catalytic body is formed within a plane above a support surface for the substrate to linearly extend over the entire length between the first and second groups of terminals.

3. The gas phase reaction processing device according to claim 1, wherein the catalytic body includes a linearly extending section and a step section between the first and second groups of terminals above a support surface for the substrate.

4. The gas phase reaction processing device according to claim 1, wherein ends of the terminals on a side supporting the catalytic bodies are situated within the processing chamber, while other ends of the terminals on the opposite side to the side supporting the catalytic bodies are situated outside the processing chamber, and the electric connection to the terminals is established from the outside of the processing chamber.

5. The gas phase reaction processing device according to claim 1, wherein the catalytic body is connected in series with the electric power unit.

6. The gas phase reaction processing device according to claim 1, wherein the catalytic body is connected in parallel with the electric power unit.

7. The gas phase reaction processing device according to claim 1, wherein the electrode structure is disposed in multiple stages above a support surface for the substrate material and the arranging direction of the catalytic body in one electrode structure is arranged at angles of 0-90° with the arranging direction of the catalytic body in another electrode structure.
